(19) United States
(12) Patent Application Publication
(10) Pub. No.: US 2025/0229896 A1
(43) Pub. Date: Jul. 17, 2025

(54) VIRTUAL WINDOW SYSTEMS AND METHODS

(71) Applicant: THE BOEING COMPANY, Arlington, VA (US)

(72) Inventor: Darren Carl McIntosh, Mukilteo, WA (US)

(73) Assignee: THE BOEING COMPANY, Arlington, VA (US)

(21) Appl. No.: 18/789,776

(22) Filed: Jul. 31, 2024

Related U.S. Application Data
(60) Provisional application No. 63/619,770, filed on Jan. 11, 2024.

(51) Int. Cl. B64D 11/00; G09G 3/00

(52) U.S. Cl. CPC B64D 11/00; G09G 3/001; B64D 2011/0061; G09G 2380/12

(57) ABSTRACT

A virtual window system includes a window, and an arcuate display spaced apart from the window. The window is in a first plane, and the arcuate display is in a second plane that differs from the first plane. The virtual window system can be within an internal cabin of a vehicle, such as a commercial aircraft.

### CROSS-REFERENCE TO RELATED APPLICATIONS

This application relates to and claims priority benefits from U.S. Provisional Patent Application No. 63/619,770, filed Jan. 11, 2024, which is hereby incorporated by reference in its entirety.

### FIELD OF THE DISCLOSURE

Examples of the present disclosure generally relate to virtual window systems and methods, such as can be used within an internal cabin of a vehicle (for example, a commercial aircraft).

### BACKGROUND OF THE DISCLOSURE

Vehicles such as commercial aircraft are used to transport passengers between various locations. A typical aircraft includes an internal cabin having seats for passengers. Windows allow passengers to look outside of the aircraft.

Certain aircraft include virtual windows, which are limited in their ability to accurately simulate an actual view of the outside landscape. Known virtual windows typically include a flat monitor mounted directly onto a window and/or window reveal.

In order to provide depth perception, certain known virtual windows include three different cameras mounted at slightly different angles. Acquired video feeds are transmitted to three different virtual windows. The camera angles are set from the perspective of someone sitting upright in a seat. Viewing this array of windows provides depth perception when a viewer occupant is seated perfectly in an upright position. However, the depth perception effect loses impact when a field of vision of an individual is located elsewhere, such as if lying flat on a bed, for example.

U.S. Pat. Nos. 10,427,792 and 10,899,453, each entitled “Vehicle With a Simulated Window Feature,” disclose a display system of a lavatory of a vehicle. U.S. Pat. Nos. 10,663,724 and 11,314,086, each entitled “Panoramic Multiplane and Transparent Collimated Display System,” disclose a display system for creating a multiplane display.

### SUMMARY OF THE DISCLOSURE

A need exists for an improved virtual window system and method. Further, a need exists for a virtual window system that provides accurate depth perception at different fields of view.

With those needs in mind, certain examples of the present disclosure provide a virtual window system including a window, and an arcuate display spaced apart from the window.

In at least one example, the window includes one or more first portions in a first plane, and the arcuate display includes one or more second portions in a second plane that differs from the first plane.

In at least one example, the arcuate display does not contact the window.

The arcuate display can include an organic light emitting diode (OLED) monitor.

The arcuate display can include a dome. As a further example, one or more projectors are configured to project images onto the dome. The one or more projectors can include a plurality of projectors disposed around a circumference of an edge of the dome. The dome can be translucent, and the one or more projectors can be disposed behind the dome.

In at least one example, the arcuate display is outboard from the window.

The virtual window system can include one or more blinkers. The one or more blinkers can be disposed on a reveal.

The virtual window system can include one or more mirrors.

In at least one example, the window is secured within an opening formed within a wall. The wall is separated from an exterior skin. The arcuate display is spaced apart from the window within a space between the wall and the exterior skin.

The arcuate display can be secured between frames. Mirrors can be on inside surfaces of the frames.

In at least one example, the window is within an internal cabin of a vehicle. The vehicle can be an aircraft. The window can be within a lavatory of the internal cabin.

Certain examples of the present disclosure provide a method of forming a virtual window system. The method includes spacing an arcuate display apart from a window.

Certain examples of the present disclosure provide a vehicle including an internal cabin, and a virtual window system, as described herein.

### BRIEF DESCRIPTION OF THE DRAWINGS

FIG. 1 illustrates a perspective front view of an aircraft, according to an example of the present disclosure.

FIG. 2 illustrates a perspective interior view of an internal cabin of an aircraft, according to an example of the present disclosure.

FIG. 3 illustrates an isometric internal view of a lavatory, according to an example of the present disclosure.

FIG. 4 illustrates a block diagram of a virtual window system within an internal cabin of an aircraft, according to an example of the present disclosure.

FIG. 5 illustrates a side section view of the virtual window system within a lavatory, according to an example of the present disclosure.

FIG. 6 illustrates a side section of the virtual window system within a lavatory, according to an example of the present disclosure.

FIG. 7 illustrates a cross-sectional view of the virtual window system through line 7-7 of FIGS. 5 and 6.

FIG. 8 illustrates a perspective view of the virtual window system from a first viewpoint of an observer, according to an example of the present disclosure.

FIG. 9 illustrates a perspective view of the virtual window system from a second viewpoint of the observer, according to an example of the present disclosure.

FIG. 10 illustrates a perspective view of the virtual window system from a third viewpoint of the observer, according to an example of the present disclosure.

FIG. 11 illustrates a front view of an arcuate display, according to an example of the present disclosure.

FIG. 12 illustrates a simplified side view of an arcuate display, according to an example of the present disclosure.

### DETAILED DESCRIPTION OF THE DISCLOSURE

The foregoing summary, as well as the following detailed description of certain embodiments will be better understood when read in conjunction with the appended drawings. As used herein, an element or step recited in the singular and preceded by the word “a” or “an” should be understood as not necessarily excluding the plural of the elements or steps. Further, references to “one embodiment” are not intended to be interpreted as excluding the existence of additional embodiments that also incorporate the recited features. Moreover, unless explicitly stated to the contrary, embodiments “comprising” or “having” an element or a plurality of elements having a particular condition can include additional elements not having that condition.

Examples of the present disclosure provide a virtual window system including a window, and an arcuate display spaced apart from the window. The window is in a first plane, and the arcuate display is in a second plane that differs from the first plane. The virtual window system can be within an internal cabin of a vehicle. The vehicle can be an aircraft. As another example, the vehicle can be a land-based vehicle, such as an automobile, a train car, a bus, or the like. As another example, the vehicle can be a watercraft, such as a cruise ship. As another example, the vehicle can be a spacecraft.

As an example, the virtual window system can be within a lavatory of the internal cabin. As another example, the virtual window system can be within an enclosed suite within the internal cabin. As another example, the virtual window system can be within a galley of the internal cabin.

Examples of the present disclosure provide a virtual window system that includes a window (such as an actual window pane, reveal, and the like) and an arcuate display disposed at a different independent plane than that of the window. Examples of the arcuate display include curved and/or domed electronic monitors, screens, projected images onto curved and/or domed surfaces, and/or the like. In at least one example, the arcuate display can be an organic light emitting diode (OLED) bendable/flexible monitor.

Because the arcuate display is disposed at a different plane than the window, the multi-plane separation creates a unique depth perception effect. In particular, when an individual moves their field of vision from side-to-side, an image on the curved display moves independently in relation to the window. Similarly, when the individual moves their field of vision up and down, the multi-plane separation creates a similar depth perception effect. The aforementioned side-to-side and up and down movement can be independent of each other, or a combination of both.

Lavatory windows within an internal cabin of an aircraft typically include a long viewing tube that connects an interior window to an exterior window. The arcuate display can be disposed within a distance typically occupied by the aforementioned viewing tube, outboard from the interior window. In such an example, the exterior window can be removed.

In at least one example, the virtual window system is particularly suited for a commercial aircraft, as it can take advantage of the unique curvature of a fuselage of the aircraft, and incorporates the arcuate display to conform to such curvature. As noted, however, the virtual window can be used with various other vehicles, such as automobiles, buses, trains, watercraft, spacecraft, and the like.

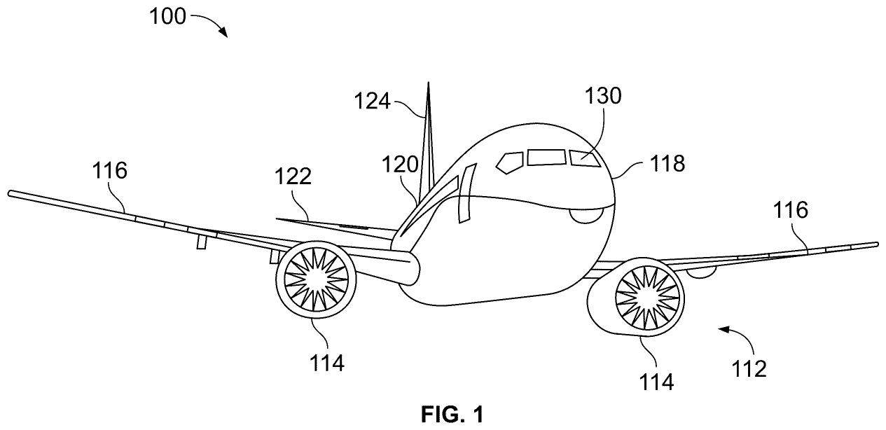

FIG. 1 illustrates a perspective front view of an aircraft 100, according to an example of the present disclosure. The aircraft 100 includes a propulsion system 112 that includes engines 114, for example. Optionally, the propulsion system 112 may include more engines 114 than shown. The engines 114 are carried by wings 116 of the aircraft 100. In other examples, the engines 114 may be carried by a fuselage 118 and/or an empennage 120. The empennage 120 may also support horizontal stabilizers 122 and a vertical stabilizer 124.

The fuselage 118 of the aircraft 100 defines an internal cabin 130, which includes a flight deck or cockpit, one or more work sections (for example, galleys, personnel carry-on baggage areas, and the like), one or more passenger sections (for example, first class, business class, and coach sections), one or more lavatories, and/or the like. As described herein, aircraft 100 includes one or more virtual window systems.

Alternatively, instead of an aircraft, virtual window systems and methods as described herein can be used with various other vehicles, such as automobiles, buses, locomotives and train cars, watercraft, spacecraft, and the like. As another example, the virtual window systems and methods described herein can be used in fixed structures, such as residential or commercial buildings.

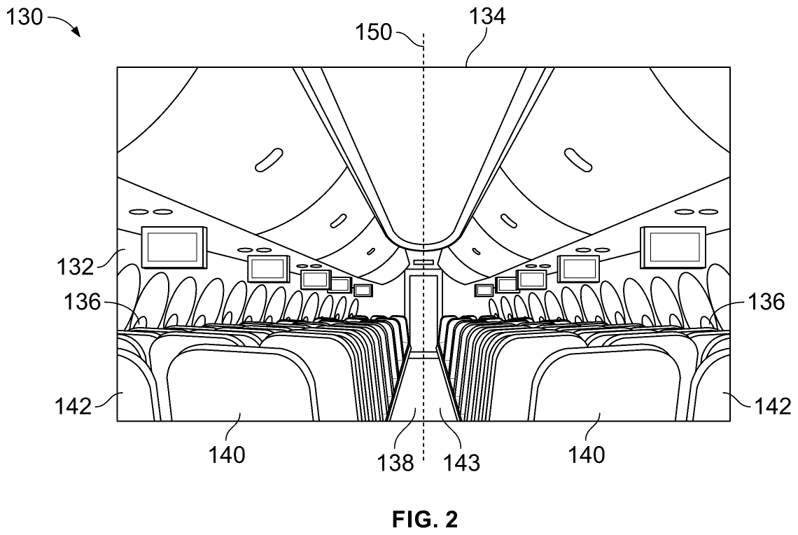

FIG. 2 illustrates a perspective interior view of an internal cabin 130 of an aircraft, according to an example of the present disclosure. The internal cabin 130 includes outboard walls 132 and a ceiling 134. Windows 136 are formed within the outboard walls 132. A floor 138 supports rows of seats 140. As shown in FIG. 2, a row 142 may include three seats 140 on either side of an aisle 143. However, the row 142 may include more or less seats 140 than shown. Additionally, the internal cabin 130 may include more aisles than shown.

One or more of the windows 136 is configured as a virtual window system, as described herein. The virtual window system can be disposed within various areas of the internal cabin 130, such as within a passenger seating area (as shown in FIG. 2), a lavatory, a galley, a first class suite, and/or the like.

As used herein, the term “outboard” means a position that is further away from a central longitudinal plane 150 of the internal cabin 130 as compared to another component. The term “inboard” means a position that is closer to the central longitudinal plane 150 of the internal cabin 130 as compared to another component.

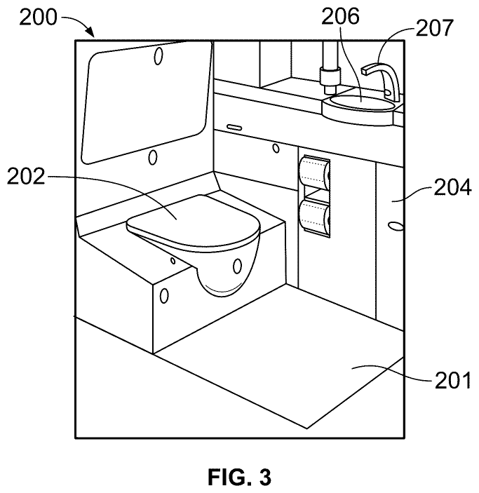

FIG. 3 illustrates an isometric internal view of a lavatory 200, according to an example of the present disclosure. In at least one example, the lavatory 200 can be disposed within an internal cabin of an aircraft. The lavatory 200 can include one or more virtual window systems, as described herein. Optionally, the lavatory 200 may be onboard various other vehicles. In other examples, the lavatory 200 may be within a fixed structure, such as a commercial or residential building. The lavatory 200 includes a base floor 201 that supports a toilet 202, one or more cabinets 204, a sink 206 or wash basin, and a faucet 207. The lavatory 200 may be arranged differently than shown. The lavatory 200 may include more or less components than shown.

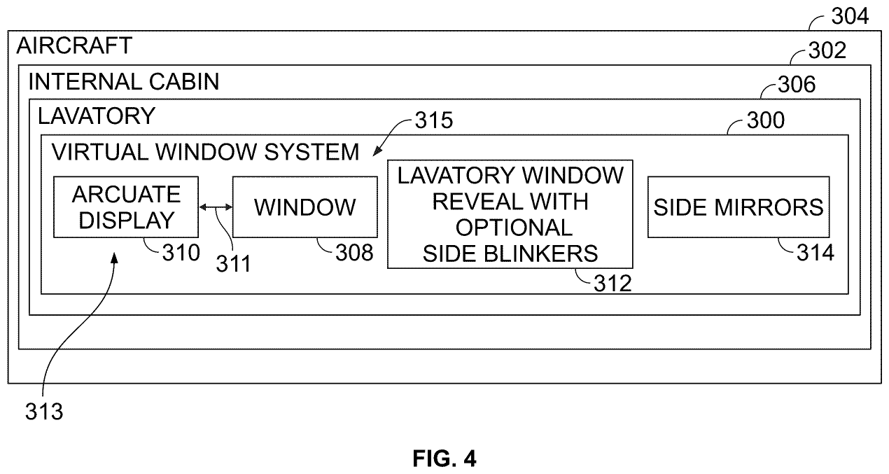

FIG. 4 illustrates a block diagram of a virtual window system 300 within an internal cabin 302 of an aircraft 304, according to an example of the present disclosure. For example, the virtual window system 300 is within a lavatory 306 of the internal cabin 302. The virtual window system 300 includes a window 308 and an arcuate display 310. The arcuate display 310 has one or more curved portions. In at least one example, the arcuate display 310 has a flat main body connected to inwardly-curved edges. As another example, the arcuate display 310 is a hemispherical dome. In at least one example, the window 308 includes a transparent pane, such as formed of glass, plastic, or the like. The pane can be secured within a frame, reveal, wall structure, and/or the like. The arcuate display 310 can be a curved electronic monitor, screen, or the like, such as a light emitting diode (LED) monitor, an OLED monitor, or the like. As another example, the arcuate display 310 can be a dome-shaped electronic monitor, screen, or the like. As an example, the arcuate display 310 can include one or more projectors that are configured to project images onto a curved and/or domed screen.

The arcuate display 310 is spaced apart from the window 308 a distance 311. As such, the arcuate display 310 has one or more portions disposed within a first plane 313, which differs from a second plane 315 in which one or more portions of the window 308 are disposed. In at least one example, no portion of the window 308 resides in a plane occupied by any portion of the arcuate display 310 (similarly, no portion of the arcuate display resided in a plane occupied by any portion of the window 308).

The virtual window system 300 can also include a lavatory window reveal 312 with optional side blinkers. Sizes and shapes of the side blinkers can be determined by projecting lines of sight at different fields of vision onto the arcuate display 310. Optionally, the virtual window system 300 may not include the side blinkers.

The virtual window system 300 can also include side mirrors 314. Optionally, the virtual window system 300 may not include the lavatory window reveal 312 or the side mirrors 314.

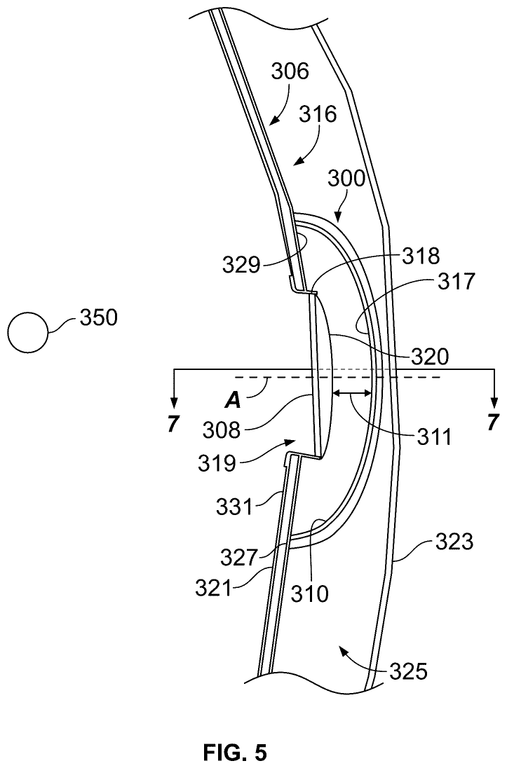

FIG. 5 illustrates a side section view of the virtual window system 300 within a lavatory 306, according to an example of the present disclosure. As shown, the virtual window system 300 can be secured to and/or within a wall 316 of the lavatory 306. The arcuate display 310 is set behind the window 308, and can surround perimeter edges 318, a rear surface, and/or side blinkers 320 of the window 308. The arcuate display 310 is spaced apart from the window 308 the distance 311. The side blinkers 320 can be disposed on a window reveal, and configured to hide structural components, such as frames of a fuselage, from view.

In at least one example, the arcuate display 310 is coaxially aligned with the window 308 along a longitudinal axis A. Optionally, the arcuate display 310 may not be coaxially aligned.

An image 317 on the arcuate display 310 moves independently from the window 308. As such, an observer 350 within the internal cabin viewing the image 317 from inside the internal cabin perceives depth within the image 317 from various different perspectives.

As shown, the window 308 is secured within an opening 319 formed within a wall 321, such as a sidewall within an internal cabin. The wall 321 is separated from an exterior skin 323, such as of a fuselage of an aircraft. The arcuate display 310 is spaced apart from the window 308, and disposed within a space 325 between the wall 321 and the exterior skin 323. In at least one example, the arcuate display 310 includes edges 327 secured to an exterior surface 329 of the wall 321. The exterior surface 329 is opposite from an interior surface 331, which faces the internal cabin.

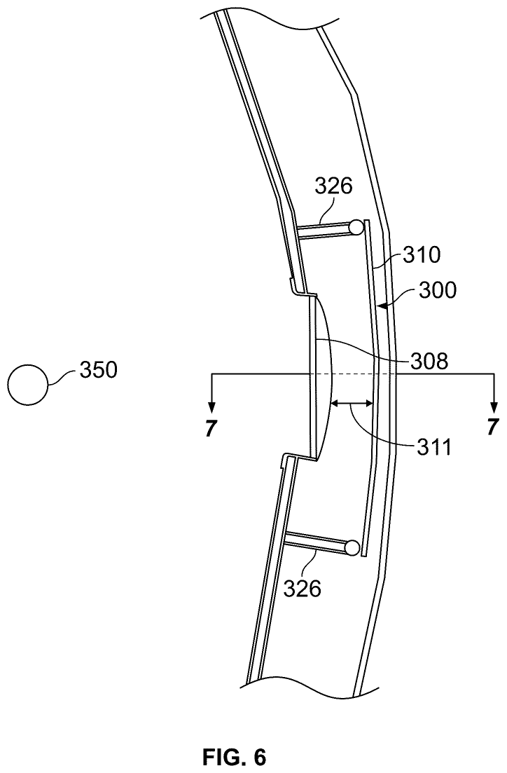

FIG. 6 illustrates a side section view of the virtual window system 300 within a lavatory 306, according to an example of the present disclosure. In this example, the arcuate display 310 can be supported by extensions 326, such as brackets, that set the arcuate display 310 the distance 311 behind the window 308.

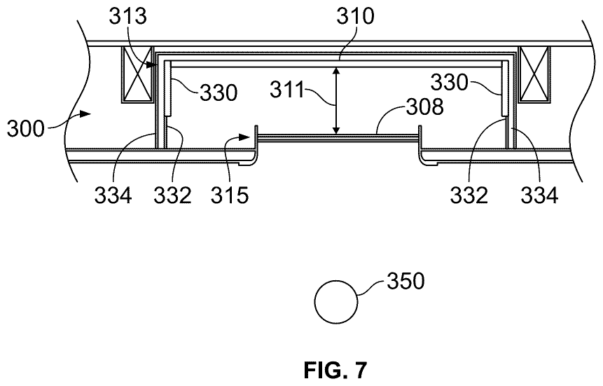

FIG. 7 illustrates a cross-sectional view of the virtual window system 300 through line 7-7 of FIGS. 5 and 6. In at least one example, the virtual window system 300 includes mirrors 330 on interior surfaces 332 of side frames 334. As shown, the arcuate display 310 is separated from the window 308 the distance 311.

Referring to FIGS. 4-7, the virtual window system 300 includes the window 308 (such as an actual window/window reveal), which can be disposed within a lavatory, and the arcuate (such as curved, domed, or the like) display 310 disposed in a different, independent plane from the window. As shown, one or more portions of the arcuate display 310 are disposed within the plane 313, while one or more portions of the window 308 are disposed within the plane 315, which is spaced apart from the plane 313. The multi-plane separation creates a unique depth perception effect to an observer 350 within the internal cabin viewing an image shown on the arcuate display 310.

In at least one example, the arcuate display 310 is secured between (such as by being nested) two or frames 334 of an aircraft, as shown in FIG. 7. The frames 334 can include the mirrors 330 on inside faces, and adjacent to the arcuate display 310. As shown in FIG. 7, the mirrors 330 can abut against edges of the arcuate display 310. The mirrors 330 hide, or obscure the frames 334 from either side. The mirrors 330 create an infinity effect in relation to the arcuate display 310.

In at least one example, a video feed to the virtual window system 300 is controlled (for example, turned on, off, and/or or changed to a different state) in response to signals received from a door lock, movement sensors, and/or the like within an internal space, such as a lavatory. The system can deactivate or revert to a sleep mode after a set amount of time of inactivity, such as within the lavatory. The video feed can further be controlled when a return to seat sign is activated. For example, when the return to seat sign is activated, this same message can be displayed on the arcuate display 310.

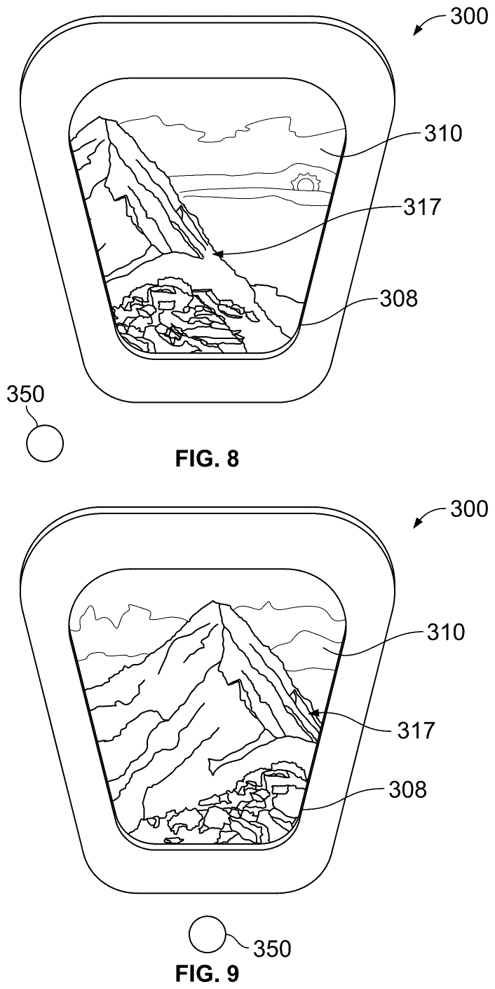

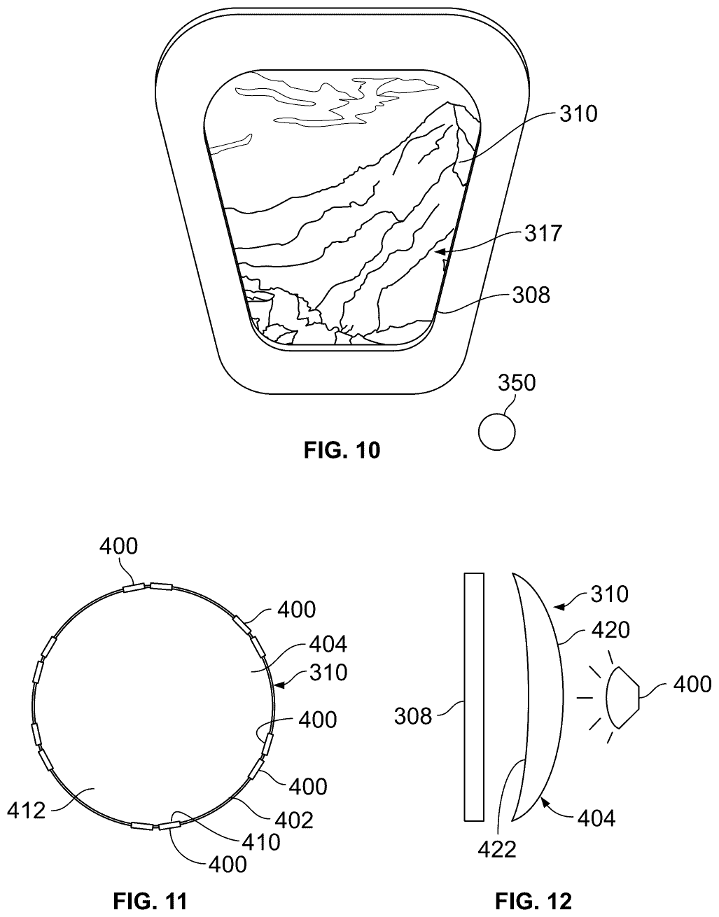

FIG. 8 illustrates a perspective view of the virtual window system 300 from a first viewpoint of an observer 350, according to an example of the present disclosure. FIG. 9 illustrates a perspective view of the virtual window system 300 from a second viewpoint of the observer 350, according to an example of the present disclosure. FIG. 10 illustrates a perspective view of the virtual window system 300 from a third viewpoint of the observer 350, according to an example of the present disclosure.

Referring to FIGS. 8-10, as the observer 350 changes viewpoint, the image 317 on the arcuate display 310 moves independently from the window 308, thereby allowing the observer to perceive changes in depth in relation to the image 317.

FIG. 11 illustrates a front view of an arcuate display 310, according to an example of the present disclosure. The arcuate display 310 can include one or more projectors 400, such as disposed around a circumference of an outer edge 402. The projectors 400 can be electronic projectors configured to project images onto a dome 404. In at least one example, the dome 404 includes a domed screen, mirrors, and/or the like. The projectors 400 can be secured to the outer edge 402 of the dome 404. The projectors 400 include image emitters 410, which point inward toward the interior surface 412 of the dome 404. Each projector 400 covers a section of the dome 404, with some overlap, until a complete surface of the dome 404 is covered. Each projector 400 is located out of sight of an individual looking at the window. That is, the individual sees the images emitted by the projectors 400, but not the projectors 400 themselves. The arcuate display 310 can include more or less projectors than shown.

FIG. 12 illustrates a simplified side view of an arcuate display 310, according to an example of the present disclosure. In at least one example, the dome 404 is a translucent dome behind the window 308. One or more projectors 400 are disposed behind the arcuate display 310 opposite from the window 308. That is, the arcuate display 310 is spaced apart from, and between the window 308 and the projector(s) 400. The projectors 400 are configured to project images on the outside 420 of the translucent dome 404 (for example, the translucent dome 404 is backlit), instead of having projectors on the inside surface 422. As such, the projectors 400 can be disposed at areas that are outside of sight lines. In at least one example, the dome 404 can be or otherwise include a translucent OLED system.

Referring to FIGS. 4-12, in an at least one example, the arcuate display 310 can include a domed projection mirror and/or screen, and one or more projectors 400 configured to project images on the domed projection screen. By using 1, 2, 3, 4, or more projectors, an entire interior area of a geodesic dome can be covered. Images can be blended if there is overlap. Images can be projected onto an interior of a dome, such as by a fisheye lens, or a spherical mirror.

As described herein, the virtual window system 300 includes the arcuate display 310 disposed within a different plane than the window 308. As such, the arcuate display 310 has one or more portions within the plane 313, and the window 308 has one or more portions within the plane 315. In at least one example, the arcuate display 310 does not contact the window 308. The different planes provide a unique depth perception for an image projected onto the arcuate display 310 (in contrast to a display mounted hard against the window). When observers move their line of sight (up/down and/or side-to-side), the relative positions of the different planes change.

The arcuate display 310 can be a fully wrap around curved display, or a slightly curved display. In at least one example, the arcuate display 310 has a radius of curvature in a vertical direction (for example, an up/down direction). The arcuate display 310 can be flat in a lateral direction (for example, a forward/aft direction), and can curve inwardly at a top and bottom, thereby hiding terminal edges of the arcuate display 310.

The width of the arcuate display 310 can be determined by structural frame spacing. In at least one example, the arcuate display 310 is wide enough so that the observer 350 cannot physically move a line of sight far enough side-to-side to see the edge of the arcuate display 310. As such, the blinkers 320 can be used to restrict the view of the side edges of the arcuate display 310. Optionally, mirrors 314 and/or 330 can be disposed on side faces, thereby concealing edges of the arcuate display 310.

In at least one example, the arcuate display 310 can include a hemispherical dome, and can include one or more projectors 400. The dome is set back from the window 308. The dome can be secured to structure, such as within an aircraft. Optionally, the dome can be configured to removably secure to the structure, such as through one or more removable connection interfaces (for example, plug and socket connections).

Further, the disclosure comprises examples according to the following clauses:

Clause 1. A virtual window system comprising:
a window; and
an arcuate display spaced apart from the window.

Clause 2. The virtual window system of Clause 1, wherein the window includes one or more first portions in a first plane, and the arcuate display includes one or more second portions in a second plane that differs from the first plane.

Clause 3. The virtual window system of Clauses 1 or 2, wherein the arcuate display does not contact the window.

Clause 4. The virtual window system of any of Clauses 1-3, wherein the arcuate display comprises an organic light emitting diode (OLED) monitor.

Clause 5. The virtual window system of any of Clauses 1-4, wherein the arcuate display comprises a dome.

Clause 6. The virtual window system of Clause 5, further comprising one or more projectors configured to project images onto the dome.

Clause 7. The virtual window system of Clause 6, wherein the one or more projectors comprise a plurality of projectors disposed around a circumference of an edge of the dome.

Clause 8. The virtual window system of Clauses 6 or 7, wherein the dome is translucent, and wherein the one or more projectors are disposed behind the dome.

Clause 9. The virtual window system of any of Clauses 1-8, wherein the arcuate display is outboard from the window.

Clause 10. The virtual window system of any of Clauses 1-9, further comprising one or more blinkers.

Clause 11. The virtual window system of Clause 10, wherein the one or more blinkers are disposed on a reveal.

Clause 12. The virtual window system of any of Clauses 1-11, further comprising one or more mirrors.

Clause 13. The virtual window system of any of Clauses 1-12, wherein the window is secured within an opening formed within a wall, wherein the wall is separated from an exterior skin, and wherein the arcuate display is spaced apart from the window within a space between the wall and the exterior skin.

Clause 14. The virtual window system of any of Clauses 1-13, wherein the arcuate display is secured between frames.

Clause 15. The virtual window system of Clause 14, further comprising mirrors on inside surfaces of the frames.

Clause 16. The virtual window system of any of Clauses 1-15, wherein the window is within an internal cabin of a vehicle.

Clause 17. The virtual window system of Clause 16, wherein the vehicle is an aircraft.

Clause 18. The virtual window system of any of Clauses 1-17, wherein the window is within a lavatory of the internal cabin.

Clause 19. A method of forming a virtual window system, the method comprising:
spacing an arcuate display apart from a window.

Clause 20. A vehicle comprising:
an internal cabin; and
a virtual window system comprising:
a window within the internal cabin, wherein the window includes one or more first portions in a first plane, wherein the window is secured within an opening formed within a wall within the internal cabin, and wherein the wall is separated from an exterior skin; and
an arcuate display spaced apart from the window within a space between the wall and the exterior skin, wherein the arcuate display includes one or more second portions in a second plane that differs from the first plane, and wherein the arcuate display is outboard from the window.

As described herein, examples of the present disclosure provide improved virtual window systems and methods. Further, examples of the present disclosure provide virtual window systems that provide accurate depth perception at different fields of view.

While various spatial and directional terms, such as top, bottom, lower, mid, lateral, horizontal, vertical, front and the like can be used to describe embodiments of the present disclosure, it is understood that such terms are merely used with respect to the orientations shown in the drawings. The orientations can be inverted, rotated, or otherwise changed, such that an upper portion is a lower portion, and vice versa, horizontal becomes vertical, and the like.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

It is to be understood that the above description is intended to be illustrative, and not restrictive. For example, the above-described embodiments (and/or aspects thereof) can be used in combination with each other. In addition, many modifications can be made to adapt a particular situation or material to the teachings of the various embodiments of the disclosure without departing from their scope. While the dimensions and types of materials described herein are intended to define the parameters of the various embodiments of the disclosure, the embodiments are by no means limiting and are exemplary embodiments. Many other embodiments will be apparent to those of skill in the art upon reviewing the above description. The scope of the various embodiments of the disclosure should, therefore, be determined with reference to the appended claims, along with the full scope of equivalents to which such claims are entitled. In the appended claims and the detailed description herein, the terms “including” and “in which” are used as the plain-English equivalents of the respective terms “comprising” and “wherein.” Moreover, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112 (f), unless and until such claim limitations expressly use the phrase “means for” followed by a statement of function void of further structure.

This written description uses examples to disclose the various embodiments of the disclosure, including the best mode, and also to enable any person skilled in the art to practice the various embodiments of the disclosure, including making and using any devices or systems and performing any incorporated methods. The patentable scope of the various embodiments of the disclosure is defined by the claims, and can include other examples that occur to those skilled in the art. Such other examples are intended to be within the scope of the claims if the examples have structural elements that do not differ from the literal language of the claims, or if the examples include equivalent structural elements with insubstantial differences from the literal language of the claims.

What is claimed is:

1. A virtual window system comprising:
a window; and
an arcuate display spaced apart from the window.

2. The virtual window system of claim 1, wherein the window includes one or more first portions in a first plane, and the arcuate display includes one or more second portions in a second plane that differs from the first plane.

3. The virtual window system of claim 1, wherein the arcuate display does not contact the window.

4. The virtual window system of claim 1, wherein the arcuate display comprises an organic light emitting diode (OLED) monitor.

5. The virtual window system of claim 1, wherein the arcuate display comprises a dome.

6. The virtual window system of claim 5, further comprising one or more projectors configured to project images onto the dome.

7. The virtual window system of claim 6, wherein the one or more projectors comprise a plurality of projectors disposed around a circumference of an edge of the dome.

8. The virtual window system of claim 6, wherein the dome is translucent, and wherein the one or more projectors are disposed behind the dome.

9. The virtual window system of claim 1, wherein the arcuate display is outboard from the window.

10. The virtual window system of claim 1, further comprising one or more blinkers.

11. The virtual window system of claim 10, wherein the one or more blinkers are disposed on a reveal.

12. The virtual window system of claim 1, further comprising one or more mirrors.

13. The virtual window system of claim 1, wherein the window is secured within an opening formed within a wall, wherein the wall is separated from an exterior skin, and wherein the arcuate display is spaced apart from the window within a space between the wall and the exterior skin.

14. The virtual window system of claim 1, wherein the arcuate display is secured between frames.

15. The virtual window system of claim 14, further comprising mirrors on inside surfaces of the frames.

16. The virtual window system of claim 1, wherein the window is within an internal cabin of a vehicle.

17. The virtual window system of claim 16, wherein the vehicle is an aircraft.

18. The virtual window system of claim 16, wherein the window is within a lavatory of the internal cabin.

19. A method of forming a virtual window system, the method comprising:
spacing an arcuate display apart from a window.

20. A vehicle comprising:
an internal cabin; and
a virtual window system comprising:
a window within the internal cabin, wherein the window includes one or more first portions in a first plane, wherein the window is secured within an opening formed within a wall within the internal cabin, and wherein the wall is separated from an exterior skin; and
an arcuate display spaced apart from the window within a space between the wall and the exterior skin, wherein the arcuate display includes one or more second portions in a second plane that differs from the first plane, and wherein the arcuate display is outboard from the window.
